(19) United States
(12) Patent Application Publication
(10) Pub. No.: US 2022/0402196 A1
(43) Pub. Date: Dec. 22, 2022

(54) PROPYLENE BASED FILAMENT FOR 3D PRINTER

(71) Applicant: Basell Polyolefine GmbH, Wesseling (DE)

(72) Inventors: Dieter Langenfelder, Niedernhausen (DE); Jürgen Rohrmann, Kelkheim (DE); Karsten Schmitz, Hofheim/Ts. (DE); Carl Schirmeister, Denzlingen (DE); Yannic Kessler, Kriftel (DE); Erik Licht, Mainz (DE); Christoph Callsen, Helmbrechts (DE); Volker Altstädt, Hamburg (DE)

(73) Assignee: Basell Polyolefine GmbH, Wesseling (DE)

(21) Appl. No.: 17/763,812

(22) PCT Filed: Sep. 28, 2020
(86) PCT No.: PCT/EP2020/077033

§ 371 Date: Mar. 25, 2022

(30) Foreign Application Priority Data
Oct. 1, 2019 (EP) 19200725.0

(51) Int. Cl. B29C 64/118; B33Y 10/00; B33Y 80/00; B33Y 70/00

(52) U.S. Cl. CPC B29C 64/118; B33Y 10/00; B33Y 80/00; B33Y 70/00; B29K 2023/12

(57) ABSTRACT

A consumable filament and process for using the consumable filament in an extrusion-based additive manufacturing system made from or containing a heterophasic polypropylene composition having a xylene soluble content ranging from 15 wt % to 50 wt %, a melt flow rate MFR L ranging from 0.5 to 100 g/10 min, an intrinsic viscosity of the fraction soluble in xylene at 25° C. ranging from 1.5 to 6.0 dl/g, and an ethylene content ranging from 10 wt % to 50 wt %.

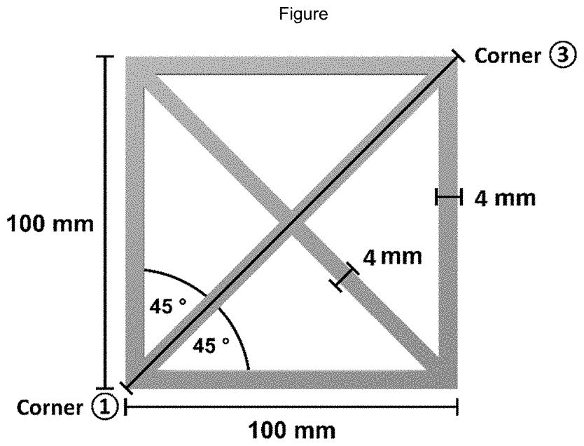

### FIELD OF THE INVENTION

In general, the present disclosure relates to the field of chemistry. More specifically, the present disclosure relates to polymer chemistry. In particular, the present disclosure relates to a filament made from or containing a heterophasic propylene ethylene copolymer and processes for producing articles from the filament.

### BACKGROUND OF THE INVENTION

An extrusion-based 3D printer is used to build a 3D model from a digital representation of the 3D model in a layer-by-layer manner by extruding a flowable modeling material. A filament of the modeling material is extruded through an extrusion tip carried by an extrusion head and deposited on a substrate in an x-y plane as a sequence of roads. The extruded modeling material fuses to previously deposited modeling material and solidifies upon a drop in temperature. The position of the extrusion head relative to the substrate is incremented along a z-axis (perpendicular to the x-y plane). The process is repeated to form a 3D model resembling the digital representation. Movement of the extrusion head with respect to the substrate is performed under computer control, in accordance with build data that represents the 3D model. The build data is obtained by initially slicing the digital representation of the 3D model into multiple horizontally sliced layers. Then, for each sliced layer, the host computer generates a build path for depositing roads of modeling material to form the 3D model.

In some instances, filaments of polylactic acid (PLA) or acrylonitrile-butadiene-styrene (ABS) polymer or polyamides are used.

In some instances, it is believed that warping results from material shrinkage while 3D printing, thereby causing the corners of the print to lift and detach from the build plate. When plastics are printed, the plastics first expand and then contract as the plastics cool down. If material contracts too much, the print bends up from the build plate and yields deformed 3D printed objects.

### SUMMARY OF THE INVENTION

In general embodiment, the present disclosure provides a filament for use in an extrusion-based additive manufacturing system, made from or containing a heterophasic polypropylene composition A) having up to 65 wt. % of a propylene homopolymer or a propylene ethylene copolymer matrix phase a1) and up to 35 wt. % of a propylene ethylene copolymer elastomeric phase a2), the sum a1)+a2) being 100, wherein the heterophasic polypropylene composition A) has a xylene soluble content ranging from 15 wt. % to 50 wt. %, a melt flow rate MFR L (Melt Flow Rate according to ISO 1133, condition L, that is, 230° C. and 2.16 kg load) ranging from 0.5 to 100 g/10 min, an intrinsic viscosity of the fraction soluble in xylene at 25° C. ranging from 1.5 to 6.0 dl/g, and an ethylene content ranging from 10 wt. % to 50 wt. %.

### BRIEF DESCRIPTION OF THE DRAWINGS

The FIGURE is the top view of a printed frame printed.

### DETAILED DESCRIPTION OF THE INVENTION

In some embodiments, the present disclosure provides a filament for use in an extrusion-based additive manufacturing system, made from or containing a heterophasic polypropylene composition A) having up to 65 wt. % of a propylene homopolymer or a propylene ethylene copolymer matrix phase a1) and up to 35 wt. % of a propylene ethylene copolymer elastomeric phase a2), the sum a1)+a2) being 100, wherein the heterophasic polypropylene composition A) has a xylene soluble content ranging from 15 wt. % to 50 wt. %, a melt flow rate MFR L (Melt Flow Rate according to ISO 1133, condition L, that is, 230° C. and 2.16 kg load) ranging from 0.5 to 100 g/10 min, an intrinsic viscosity of the fraction soluble in xylene at 25° C. ranging from 1.5 to 6.0 dl/g, and an ethylene content ranging from 10 wt. % to 50 wt. %.

In some embodiments, the present disclosure provides a process for producing a filament for an extrusion-based additive manufacturing system, wherein the filament is made from or containing a heterophasic polypropylene composition A) having up to 65 wt. % of a propylene homopolymer or a propylene ethylene copolymer matrix phase a1) and up to 35 wt. % of a propylene ethylene copolymer elastomeric phase a2), the sum a1)+a2) being 100, wherein the heterophasic polypropylene composition A) has a xylene soluble content ranging from 15 wt. % to 50 wt. %, a melt flow rate MFR L (Melt Flow Rate according to ISO 1133, condition L, that is, 230° C. and 2.16 kg load) ranging from 0.5 to 100 g/10 min, an intrinsic viscosity of the fraction soluble in xylene at 25° C. ranging from 1.5 to 6.0 dl/g and an ethylene content ranging from 10 wt. % to 50 wt. %.

In some embodiments, the filament is used as a consumable filament in an extrusion-based additive manufacturing system.

In some embodiments, the heterophasic polypropylene composition A) has a xylene soluble content ranging from 15 wt. % to 50 wt. %, alternatively from 20 wt. % to 40 wt. %, alternatively from 25 wt. % to 35 wt. %.

In some embodiments, the heterophasic polypropylene composition A) has a melt flow rate MFR L (Melt Flow Rate according to ISO 1133, condition L, that is, 230° C. and 2.16 kg load) ranging from 0.5 to 100 g/10 min, alternatively from 2.0 to 50 g/10 min, alternatively from 5.0 to 20 g/10 min.

In some embodiments, the heterophasic polypropylene composition A) has an intrinsic viscosity of the fraction soluble in xylene at 25° C. ranging from 1.5 to 6.0 dl/g, alternatively from 1.8 to 4.0 dl/g, alternatively from 2.0 to 2.8 dl/g, alternatively from 2.0 to less than 2.5 dl/g.

In some embodiments, the heterophasic polypropylene composition A) has an ethylene content ranging from 10 wt. % to 50 wt. %; alternatively from 15 wt. % to 40 wt. %; alternatively from 20 wt. % to 30 wt. %.

As used herein, the term “heterophasic polypropylene composition” refers to an elastomeric propylene ethylene copolymer rubber finely dispersed in a propylene homopolymer or copolymer matrix. In some embodiments, the elastomeric propylene ethylene copolymer rubber forms inclusions in the matrix. In some embodiments, the matrix contains (finely) dispersed inclusions being not part of the matrix, wherein the inclusions contain the elastomeric propylene ethylene copolymer. As used herein, the term “inclusion” refers to the matrix and the inclusion forming different phases within the heterophasic system. In some embodiments, the inclusions are visible by high-resolution microscopy. In some embodiments, the high-resolution microscopy is selected from the group consisting of electron microscopy and scanning force microscopy.

As used herein, the term “copolymer” refers to a polymer formed by two monomers. In some embodiments, the monomers are propylene and ethylene.

As used herein, the term “xylene soluble” or “xylene soluble fraction” refers to a fraction soluble in xylene at 25° C.

In some embodiments, the matrix a1) of the heterophasic propylene ethylene copolymer is propylene homopolymer or propylene ethylene copolymer having an ethylene content up to 10 wt. %; alternatively up to 5 wt. %. In some embodiments, the matrix is a propylene homopolymer.

In some embodiments, the matrix a1) has a fraction insoluble in xylene at 25° C. higher than 90 wt %, alternatively higher than 95 wt. %, alternatively higher than 97 wt. %.

In some embodiments, the elastomeric phase a2) is a propylene ethylene copolymer. In some embodiments, the propylene ethylene copolymer has an ethylene content ranging from 20 wt. % to 90 wt. %; alternatively from 35 wt. % to 85 wt. %, alternatively from 50 wt. % to 80 wt. %.

In some embodiments, the filament is made from or containing a filled polyolefin composition made from or containing:
A) from 60 wt. % to 95 wt. %; alternatively from 65 wt. % to 92 wt. %, alternatively from 70 wt. % to 90 wt. %, of a heterophasic polypropylene composition comprising:

a1) from 30 wt. % to 65 wt. %; of a propylene homopolymer or a propylene/ethylene copolymer having a content of ethylene derived units ranging from 0.1 wt. % to 4.5 wt. %; and having a xylene soluble content measured at 25° C. lower than 10 wt. %;

a2) from 35 wt. % to 70 wt. % of a propylene ethylene copolymer having a content of ethylene derived units ranging from 20 wt. % to 90 wt. %; alternatively from 35 wt. % to 85 wt. %; alternatively from 50 wt. % to 80 wt. %,

the sum a1+a2 being 100,

wherein the heterophasic polypropylene composition A) has a xylene soluble content ranging from 15 wt. % to 50 wt. %; alternatively from 20 wt. % to 40 wt. %, alternatively from 22 wt. % to 35 wt. %, a melt flow rate MFR L (Melt Flow Rate according to ISO 1133, condition L, that is, 230° C. and 2.16 kg load) ranging from 0.5 to 100 g/10 min; alternatively from 2.0 to 50 g/10 min; alternatively from 5.0 to 20 g/10 min, an intrinsic viscosity of the fraction soluble in xylene at 25° C. ranging from 1.5 to 6.0 dl/g, alternatively from 1.8 to 4.0 dl/g, alternatively from 2.0 to 2.8 dl/g, alternatively from 2.0 to less than 2.5 dl/g, and an ethylene content ranging from 10 wt. % to 50 wt. %; alternatively from 15 wt. % to 40 wt. %; alternatively from 20 wt. % to 30 wt. %; and

B) from 5.0 wt. % to 40.0 wt. %, alternatively from 8.0 wt. % to 35 wt. %, alternatively from 10 wt. % to 30 wt. %, of a filler,

the sum A+B being 100.

In some embodiments, the resulting filled polyolefin composition has a melt flow rate (230° C./5 kg. ISO 1133) ranging from 2.0 to 30 g/10 min, alternatively from 7.0 g/10 min to 15.0 g/10 min.

In some embodiments, the filler is selected from the group consisting of talc, mica, calcium carbonate, wollastonite, glass fibers, glass spheres and carbon derived grades. In some embodiments, the filler is glass fibers.

In some embodiments, the glass fibers are chopped glass fibers. In some embodiments, the glass fibers are referred to as short glass fibers or chopped strands.

In some embodiments and before being added to the composition, the short glass fibers have a length of from 1 to 5 mm, alternatively from 3 to 4.5 mm.

In some embodiments and before being added to the composition, the short glass fibers have a diameter of from 8 to 20 μm, alternatively from 10 to 14 μm.

In some embodiments, the filler is glass fibers, and the filament is further made from or containing a compatibilizer.

In some embodiments, the compatibilizer improves interfacial properties between mineral fillers and polymers. In some embodiments, the compatibilizer reduces the agglomeration tendency of filler particles, thereby improving their dispersion within the polymer matrix.

In some embodiments, the compatibilizer is selected from the group consisting of low molecular weight compounds having reactive polar groups for increasing the polarity of the polyolefin and which react with the functionalized coating or sizing of the fillers, thereby enhancing compatibility with the polymer. In some embodiments, the functionalized coatings of the fillers are silanes. In some embodiments, the silanes are selected from the group consisting of aminosilanes, epoxysilanes, amidosilanes and acrylosilanes. In some embodiments, the silane is an aminosilane.

In some embodiments, the compatibilizers are made from or containing a polymer modified (functionalized) with polar moieties and, optionally, a low molecular weight compound having reactive polar groups.

In some embodiments and in terms of structure, the modified polymers are graft or block copolymers. In some embodiments, the modified polymers contain groups deriving from polar compounds. In some embodiments, the polar compounds are selected from the group consisting of, acid anhydrides, carboxylic acids, carboxylic acid derivatives, primary and secondary amines, hydroxyl compounds, oxazoline and epoxides, and ionic compounds.

In some embodiments, the polar compounds are selected from the group consisting of unsaturated cyclic anhydrides and their aliphatic diesters, and the diacid derivatives. In some embodiments, the polar compounds are selected from the group consisting of maleic anhydride, C₁-C₁₀ linear and branched dialkyl maleates, C₁-C₁₀ linear and branched dialkyl fumarates, itaconic anhydride, C₁-C₁₀ linear and branched itaconic acid dialkyl esters, maleic acid, fumaric acid, itaconic acid and mixtures thereof.

In some embodiments, the compatibilizer is a propylene polymer grafted with maleic anhydride.

In some embodiments, the coupling agent is a maleic anhydride grafted polypropylene.

In some embodiments, the filament is made from or containing a polyolefin composition made from or containing up to 2.0 wt. %, alternatively 0.1-1.5 wt. %, of a compatibilizer, the amount of compatibilizer being referred to the total weight of the polyolefin composition. In some embodiments, the compatibilizer is a propylene polymer grafted with maleic anhydride.

In some embodiments, the heterophasic polypropylene composition A) is commercially available from LyondellBasell. In some embodiments, the heterophasic polypropylene composition A) Hifax Calif. 7442A copolymer, which is commercially available from LyondellBasell.

In some embodiments, the filament is further made from or containing additives. In some embodiments, the additives are selected from the group consisting of antioxidants, slipping agents, process stabilizers, antiacid and nucleants.

In some embodiments, the filament is further made from or containing wood powder, metallic powder, marble powder and similar materials. In some embodiments, these components affect the aesthetic appearances or mechanics of the 3D object.

In some embodiments, the present disclosure provides a process for producing articles with an extrusion-based additive manufacturing system including the step of extruding a flowable build material obtained from the filament.

In some embodiments, the process for producing a 3D printed article includes the steps of:

(i) providing a filament, made from or containing a heterophasic polypropylene composition A) having up to 65 wt. % of a propylene homopolymer or a propylene ethylene copolymer matrix phase a1) and up to 35 wt. % of a propylene ethylene copolymer elastomeric phase a2), the sum a1) +a2) being 100, wherein the heterophasic polypropylene composition A) has a xylene soluble content ranging from 15 wt. % to 50 wt. %, a melt flow rate MFR L (Melt Flow Rate according to ISO 1133, condition L, that is, 230° C. and 2.16 kg load) ranging from 0.5 to 100 g/10 min, an intrinsic viscosity of the fraction soluble in xylene at 25° C. ranging from 1.5 to 6.0 dl/g and an ethylene content ranging from 10 wt. % to 50 wt. %,

(ii) producing a 3D printed article from the filament or extruding a flowable build material obtained from the filament.

In some embodiments, the present disclosure provides a process for producing articles with an extrusion-based additive manufacturing system further including the step of fusing deposited strands, drops, or beads of the heterophasic polypropylene composition A) or of the filled polyolefin composition.

The following examples are given to illustrate and not to limit the subject matter as presented in the accompanying claims.

### EXAMPLES

The data of the propylene polymer materials were obtained according to the following methods:

Xylene-soluble fraction at 25° C.

The Xylene Soluble fraction was measured according to ISO 16152, 2005, but with the following deviations (the ISO 16152-specified conditions are within the parentheses).

The solution volume was 250 ml (200 ml).

During the precipitation stage at 25° C. for 30 min, the solution, for the final 10 minutes, was kept under agitation by a magnetic stirrer (30 min, without stirring).

The final drying step was done under vacuum at 70° C. (100° C.).

The content of the xylene-soluble fraction is expressed as a percentage of an original 2.5 grams sample and then, by difference (complementary to 100), the xylene insoluble %.

Ethylene (C2) Content

¹³C NMR of Propylene/Ethylene Copolymers

¹³C NMR spectra were acquired on a Bruker AV-600 spectrometer equipped with cryoprobe, operating at 160.91 MHz in the Fourier transform mode at 120° C.

The peak of the S_{ββ} carbon (nomenclature according to “Monomer Sequence Distribution in Ethylene-Propylene Rubber Measured by 13C NMR. 3. Use of Reaction Probability Mode” C. J. Carman, R. A. Harrington and C. E. Wilkes, Macromolecules, 1977, 10, 536) was used as internal reference at 29.9 ppm. The samples were dissolved in 1,1,2,2-tetrachloroethane-d2 at 120° C. with an 8% wt./v concentration. Each spectrum was acquired with a 90° pulse, 15 seconds of delay between pulses and CPD to remove 1H-13C coupling. 512 transients were stored in 32K data points using a spectral window of 9000 Hz.

The assignments of the spectra, the evaluation of triad distribution and the composition were made according to Kakugo (“Carbon-13 NMR determination of monomer sequence distribution in ethylene-propylene copolymers prepared with δ-titanium trichloride-diethylaluminum chloride” M. Kakugo, Y. Naito, K. Mizunuma and T. Miyatake, Macromolecules, 1982, 15, 1150) using the following equations:

$$PPP = 100 {T}_{ββ} / S PPE = 100 {T}_{βδ} / S EPE = 100 {T}_{δδ} / S$$

$$PEP = 100 {S}_{ββ} / S PEE = 100 {S}_{βδ} / S EEE = 100 ( 0.25 {S}_{γδ} + 0.5 {S}_{δδ} ) / S$$

$$S = {T}_{ββ} + {T}_{βδ} + {T}_{δδ} + {S}_{ββ} + {S}_{βδ} + 0.25 {S}_{γδ} + 0.5 {S}_{δδ}$$

The molar percentage of ethylene content was evaluated using the following equation:

E % mol=100*[PEP+PEE+EEE]

The weight percentage of ethylene content was evaluated using the following equation:

$$E \% wt . = \frac{100 * E \% mol * {MW}_{E}}{E \% mol * {MW}_{E +} P \% mol * {MW}_{P}}$$

where P % mol is the molar percentage of propylene content, while MW_{E} and MW_{P} are the molecular weights of ethylene and propylene, respectively.

The product of reactivity ratio r₁r₂ was calculated according to Carman (C. J. Carman, R. A. Harrington and C. E. Wilkes, Macromolecules, 1977; 10, 536) as:

$${r}_{1} {r}_{2} = 1 + ( \frac{EEE + PEE}{PEP} + 1 ) - ( \frac{P}{E} + 1 ) {( \frac{EEE + PEE}{PEP} + 1 )}^{0.5}$$

The tacticity of Propylene sequences was calculated as mm content from the ratio of the PPP mmT_{ββ} (28.90-29.65 ppm) and the whole T_{ββ} (29.80-28.37 ppm)

Melt Flow Rate (MFR) and Melt Volume Rate (MVR)

The melt flow rate MFR and the melt volume flow rate of the polymer and of the composition were determined according to ISO 1133-1 2011 (230° C., 2.16 Kg).

Intrinsic Viscosity

The intrinsic viscosity was determined in tetrahydronaphthalene at 135° C.

Mechanical Properties: Tensile Properties and Charpy Impact Strength

Tensile properties were measured with tensile specimens DIN EN ISO 527-1 Type 1A according to the procedure DIN EN ISO 527:2012.

Charpy impact strength was measured with notched specimens DIN EN ISO 179-1eA at 23° C. according to the procedure DIN EN ISO 179-1 on rectangular specimens 80×10×4 mm from injection molded T-bars prepared according to Test Method ISO 19069-1 (2015).

Shrinkage

Shrinkage values were measured according to an internal method. This method is based on ISO 294-4 but with different specimen dimensions and using digital gauges directly connected to a computer, thereby ensuring a constant contact pressure in the same positions for the samples.

Processing shrinkage and total shrinkage were determined on a plate with the dimensions of 195 mm×100 mm×2.5 mm and a smooth surface (without grain structure), using a measurement frame with the same dimensions and integrated digital gauges.

Processing shrinkage was determined after 48 hours storage at room temperature on ten plates for each material, both in machine direction (MD) and transverse direction (TD) and by calculating the averages.

Total shrinkage was determined after storage of the same plates at 80° C. for 24 hours on ten plates for each material plates, both in machine direction (MD) and transverse direction (TD). The total shrinkage was measured after the plates returned to room temperature.

Warpage Measurement on a Printed Cube

The warpage was measured on a 3D printed cube with an edge length of 20 mm. The verification was carried out by a two-step process: in the first step, images were taken (using a Leica DM6000 light microscope, objective 5×) of those cube edges which had the first printed layers of the cubes. The viewing direction of the images corresponded to the X-Z plane of a right-handed X-Y-Z coordinate system, where X is one of the two horizontal axes. In the second step, the images were evaluated using the software ImageJ, thereby setting the scales of light microscopic images in the software as scale references and outputting the distance between two pixels in a real length specification. This procedure was applied to the cubes as follows: the tangent through the lowest point of the recorded edge was taken as the baseline, or print bed line, and drawn into the image. Subsequently and on at least 3 cubes, the distance between the respectively right-hand end of the cube edge and the baseline was measured by the software functions, thus determining the distortion in mm.

Warpage Measurement on a Printed Frame

Warpage was measured on a 3D printed frame having geometry according to the FIGURE.

Warpage values were established by placing the frame on a flat surface and measuring the height of the four corner positions with respect to the surface itself. Three specimens were printed and measured for each material composition.

### Example 1

### Comparative Example

The composition was built up with:
98.4 wt. % of a polypropylene homopolymer (PP homo 1, Moplen HF 501N, having a MFR 10.0 g/10 min, commercially available from LyondellBasell Industries);
0.6 wt. % of a polypropylene homopolymer (PP homo 2, Moplen HF 500H, having a MFR 1.2 g/10 min, commercially available from LyondellBasell Industries); and
1.0 wt. % of an additive package made from or containing 0.30 wt % of Irgafos® 168, 0.40 wt % of Irganox® 1010, BASF, 0.20 wt % of Acrawax C®, Lonza, and 0.10 wt % of zinc oxide.

### Example 2

The composition was built up with:
98.4 wt. % of a polypropylene heterophasic copolymer (PP heco 1, Hifax Calif. 7442A, commercially available from LyondellBasell Industries, having MFR 12.0 g/10 min, xylene soluble content 30.0 wt. %, intrinsic viscosity of the fraction soluble in xylene at 25° C. 2.30 dl/g, ethylene content 27.5 wt. %, matrix 60%, and ethylene in the rubber phase 68 wt. %);
0.6 wt. % of a polypropylene homopolymer (PP homo 2, Moplen HF 500H, having a MFR 1.2 g/10 min, commercially available from LyondellBasell Industries); and
1.0 wt. % of an additive package made from or containing 0.30 wt. % of Irgafos® 168, 0.40 wt. % of Irganox® 1010, BASF, 0.20 wt. % of Acrawax C®, Lonza, and 0.10 wt. % of zinc oxide.

### Example 3

### Comparative Example

The composition was built up with:
77.4 wt. % of a polypropylene homopolymer (PP homo 1, Moplen HF 501N, having a MFR 10.0 g/10 min, commercially available from LyondellBasell Industries);
0.6 wt. % of a polypropylene homopolymer (PP homo 2, Moplen HF 500H, having a MFR 1.2 g/10 min, commercially available from LyondellBasell Industries);
20.0 wt. % of short glass fibers, Thermoflow® CS EC 13636, length 4 mm, diameter 13 micron;
1.0 wt. % of maleic anhydride grafted polypropylene (Exxcelor PO 1020, commercially available from ExxonMobil Chemical); and
1.0 wt. % of an additive package made from or containing 0.30 wt. % of Irgafos® 168, 0.40 wt. % of Irganox® 1010, BASF, 0.20 wt. % of Acrawax C®, Lonza, and 0.10 wt. % of zinc oxide.

### Example 4

### Comparative Example

The composition was built up with:
78.4 wt. % of a polypropylene homopolymer (PP homo 1, Moplen HF 501N, having a MFR 10.0 g/10 min, commercially available from LyondellBasell Industries);
0.6 wt. % of a polypropylene homopolymer (PP homo 2, Moplen HF 500H, having a MFR 1.2 g/10 min, commercially available from LyondellBasell Industries);
20.0 wt. % of talc 20 MOOS, Imerys, having d50 particle size distribution of 50 micron; and
1.0 wt. % of an additive package made from or containing 0.30 wt. % of Irgafos® 168, 0.40 wt. % of Irganox® 1010, BASF, 0.20 wt. % of Acrawax C®, Lonza, and 0.10 wt. % of zinc oxide.

### Example 5

The composition was built up with:
77.4 wt. % of a polypropylene heterophasic copolymer (PP heco 1, Hifax Calif. 7442A, having a MFR 12.0 g/10 min, commercially available from LyondellBasell Industries);
0.6 wt. % of a commercial polypropylene homopolymer (PP homo 2, Moplen HF 500H, having a MFR 1.2 g/10 min, commercially available from LyondellBasell Industries);
20.0 wt. % of short glass fibers, Thermoflow® CS EC 13636, length 4 mm, diameter 13 micron;
1.0 wt. % of maleic anhydride grafted polypropylene (Exxcelor PO 1020, commercially available from ExxonMobil Chemical); and
1.0 wt. % of an additive package made from or containing 0.30 wt. % of Irgafos® 168, 0.40 wt. % of Irganox® 1010, BASF, 0.20 wt. % of Acrawax C®, Lonza, and 0.10 wt. % of zinc oxide.

### Example 6

The composition was built up with:
78.4 wt. % of a polypropylene heterophasic copolymer (PP heco 1, Hifax Calif. 7442A, having a MFR 12.0 g/10 min, commercially available from LyondellBasell Industries);
0.6 wt. % of a polypropylene homopolymer (PP homo 2, Moplen HF 500H, having a MFR 1.2 g/10 min, commercially available from LyondellBasell Industries);
20.0 wt. % of talc 20 MOOS, Imerys, having d50 particle size distribution of 50 micron; and
1.0 wt. % of an additive package made from or containing 0.30 wt. % of Irgafos® 168, 0.40 wt. % of Irganox® 1010, BASF, 0.20 wt. % of Acrawax C®, Lonza, and 0.10 wt. % of zinc oxide.

### Example 7

### Comparative Example

Example 7 is a high crystallinity propylene copolymer (PP copo 1, Moplen EP3307, having MFR 14.0 g/10 min, xylene soluble content 26.0 wt %, intrinsic viscosity of the fraction soluble in xylene at 25° C. 3.1 dl/g, ethylene content 15 wt %, and matrix 68.5 wt %, commercially available from LyondellBasell Industries).

### Example 8

Example 8 is a polypropylene heterophasic copolymer copolymer (PP heco 1, Hifax CA 7442A, having a MFR 12.0 g/10 min, commercially available from LyondellBasell Industries).

Compositions of Examples 1, 2, 7 and 8 were prepared with a twin-screw extruder Krupp Werner & Pfleiderer/1973, ZSK 53, screw diameter: 2×53, 36D with a screw rotation speed of 200 rpm and a melt temperature of 230° C.

Compositions of Examples 3-6 were prepared with a twin-screw extruder Leistritz/2013, ZSE 27MAXX, screw diameter: 2×28,3, 44D with a screw rotation speed of 500 rpm and a melt temperature of 230° C.

Material Characterization

The characterization of compositions of examples 1-6 is reported in Table 1.

TABLE 1

| | Ex. 1 - | | Ex. 3 - | Ex. 4 - | | |
|---|---|---|---|---|---|---|
| Properties | Comp. | Ex. 2 | Comp. | Comp. | Ex. 5 | Ex. 6 |
| MFR [g/10 min] | 9.1 | 10.0 | 5.3 | 10.0 | 5.8 | 11.0 |
| MVR [g/10 min] | 12.0 | 14.0 | 6.2 | 12.0 | 6.7 | 13.0 |

Tensile test

| | | | | | | |
|---|---|---|---|---|---|---|
| Tensile Modulus | 1412 | 1232 | 4479 | 2750 | 3261 | 1435 |
| with break [N/mm²] | | | | | | |
| Tensile Stress at | 33.5 | 20.6 | 72.4 | 36.8 | 38.9 | 18.8 |
| yield [N/mm²] | | | | | | |
| Elongation at yield | 10.0 | 6.6 | 3.1 | 5.9 | 4.9 | 6.8 |
| [%] | | | | | | |
| Tensile strength | 33.8 | 20.7 | 72.4 | 36.8 | 38.9 | 18.9 |
| [N/mm²] | | | | | | |
| Tensile stress at | 33.8 | 16.9 | 70.7 | 9.8 | 35.7 | 11.1 |
| break [N/mm²] | | | | | | |
| Elongation at break | 670.8 | 61.0 | 3.9 | 50.4 | 7.9 | 118.4 |
| [%] | | | | | | |

Charpy notched

| | | | | | | |
|---|---|---|---|---|---|---|
| Charpy Notched | 4.38 | 14.51 | 8.97 | 3.66 | 21.55 | 26.40 |
| Impact Strength 23 | | | | | | |
| ° C. [kJ/m²] | | | | | | |

Shrinkage

| | | | | | | |
|---|---|---|---|---|---|---|
| Mold shrinkage | 1.33/1.49 | 0.60/0.87 | 0.37/0.99 | 1.18/1.33 | 0.14/0.54 | 0.42/0.67 |
| (MD/TD) [%] | | | | | | |
| Total shrinkage | 1.63/1.82 | 0.71/1.00 | 0.40/1.14 | 1.48/1.51 | 0.15/0.57 | 0.50/0.77 |
| (MD/TD) [%] | | | | | | |

Filament Production

A Brabender twin-screw extruder was used. The die direction was 90° to the extrusion direction downwards.
Pellet dosing: hopper
Die diameter: 3 mm.
Filament diameter: 2.85 mm.
Strand cooling: water bath.
Pulling velocity: 30-66 mm/s.

Warpage Measurement

Warpage was evaluated in two different ways: the first one was on a printed cube and the second one on a printed frame.

Printing Process for the Cube

The 3D printer was a DeltaTowerDual XL printer. The printer conditions were the following:
Maximum build volume: 500×500×900 mm
Maximum nozzle temperature: 295° C.
Maximum bed temperature (build-in): 75° C.
Maximum bed temperature (external): 150° C.
Print heads: 2 extruders with interchangeable 0.4 mm (brass) and 0.8 mm (hardened steel) dies
Slicer: Simplify3D
Die: 0.8 mm bronze die
Die temperatures: 165-215° C.
Bed temperatures: 80-140° C.
Printing speed: 30-40 mm/s

Table 2 shows the average deviation of the cube edge from the target dimension in mm (theoretical cube edge).

TABLE 2

| | Average deviation from the |
|---|---|
| Material | target dimension [mm] |
| Ex. 1 - Comparative | 0.103 |
| Ex. 2 | 0.035 |
| Ex. 3 - Comparative | 0.035 |
| Ex. 4 - Comparative | 0.075 |
| Ex. 5 | 0.031 |
| Ex. 6 | 0.060 |

Printing Process for the Frame

A frame with the geometry according to the FIGURE was printed.

The 3D printer was a Ultimaker S5. The printer conditions were the following:
Slicer: Cura
Die: 0.4 mm bronze die
Die temperature: 210° C.
Bed temperature: 90° C.
Printing speed: 25 mm/s

Table 3 shows the warpage behavior of the frames.

TABLE 3

| | | Corner 1 | Corner 2 | Corner 3 | Corner 4 |
|---|---|---|---|---|---|
| Material | | [mm] | [mm] | [mm] | [mm] |
| Ex. 7 - | Frame 1 | 5.8 | 6.0 | 7.0 | 5.0 |
| Comparative | Frame 2 | 6.1 | 6.6 | 6.2 | 5.9 |
| | Frame 3 | 5.0 | 7.0 | 5.0 | 5.5 |
| Ex. 8 | Frame 1 | 2.8 | 2.8 | 2.2 | 2.6 |
| | Frame 2 | 3.1 | 2.9 | 3.5 | 2.3 |
| | Frame 3 | 5.4 | 3.9 | 4.1 | 3.6 |

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. A process for producing a 3D printed article comprising the steps of:
(i) providing a filament, comprising
a heterophasic polypropylene composition A) having
up to 65 wt. % of a propylene homopolymer or a propylene ethylene copolymer matrix phase a1) and
up to 35 wt. % of a propylene ethylene copolymer elastomeric phase a2), the sum a1)+a2) being 100,
wherein the heterophasic polypropylene composition A) has a xylene soluble content ranging from 15 wt. % to 50 wt. %, a melt flow rate MFR L (Melt Flow Rate according to ISO 1133, condition L, that is 230° C. and 2.16 kg load) ranging from 0.5 to 100 g/10 min, an intrinsic viscosity of the fraction soluble in xylene at 25° C. ranging from 1.5 to 6.0 dl/g and an ethylene content ranging from 10 wt. % to 50 wt. %, and
(ii) producing a 3D printed article from the filament.

14. (canceled)

15. The process for producing a 3D printed article according to claim 13, wherein the heterophasic polypropylene composition A) has a xylene soluble content ranging from 20 wt. % to 40 wt. %.

16. The process for producing a 3D printed article according to claim 13, wherein the heterophasic polypropylene composition A) has a xylene soluble content ranging from 22 wt. % to 35 wt. %.

17. The process for producing a 3D printed article according to claim 13, wherein the heterophasic polypropylene composition A) has a melt flow rate MFR L (ISO 1133, condition L, that is, 230° C. and 2.16 kg load) ranging from 2.0 to 50 g/10 min.

18. The process for producing a 3D printed article according to claim 13, wherein the heterophasic polypropylene composition A) has a melt flow rate MFR L (ISO 1133, condition L, that is, 230° C. and 2.16 kg load) ranging from 5.0 to 20 g/10 min.

19. The process for producing a 3D printed article according to claim 13, wherein the heterophasic polypropylene composition A) has an intrinsic viscosity of the fraction soluble in xylene at 25° C. ranging from 1.8 to 4.0 dl/g.

20. The process for producing a 3D printed article according to claim 13, wherein the heterophasic polypropylene composition A) has an intrinsic viscosity of the fraction soluble in xylene at 25° C. ranging from 2.0 to less than 2.5 dl/g.

21. The process for producing a 3D printed article according to claim 13, wherein the heterophasic polypropylene composition A) has an ethylene content ranging from 15 wt. % to 40 wt. %.

22. The process for producing a 3D printed article according to claim 13, wherein the heterophasic polypropylene composition A) has an ethylene content ranging from 20 wt. % to 30 wt. %.

23. The process for producing a 3D printed article according to claim 13, wherein the filament comprises a filled polyolefin composition comprising:
A) from 60 wt. % to 95 wt. % of a heterophasic polypropylene composition comprising:
a1) from 30 wt. % to 65 wt. % of a propylene homopolymer or a propylene/ethylene copolymer having a content of ethylene derived units ranging from 0.1 wt. % to 4.5 wt. %, and having a xylene soluble content measured at 25° C. lower than 10 wt. %; and
a2) from 35 wt. % to 70 wt. % of a propylene ethylene copolymer having a content of ethylene derived units ranging from 35 wt. % to 85 wt. %,
the sum a1+a2 being 100,
wherein the heterophasic polypropylene composition A) has a xylene soluble content ranging from 15 wt. % to 50 wt. %, a melt flow rate MFR L (ISO 1133, condition L, that is, 230° C. and 2.16 kg load) ranging from 0.5 to 100 g/10 min, an intrinsic viscosity of the fraction soluble in xylene at 25° C. ranging from 1.5 to 6.0 dl/g and an ethylene content ranging from 10 wt. % to 50 wt. %; and
B) from 5.0 wt. % to 40.0 wt. % of a filler,
the sum A+B being 100.

24. The process for producing a 3D printed article according to claim 23, wherein the filler is selected from the group consisting of talc, mica, calcium carbonate, wollastonite, glass fibers, glass spheres and carbon derived grades.

25. The process for producing a 3D printed article according to claim 24, wherein the filler is glass fibers.

26. The process for producing a 3D printed article according to claim 25, wherein the polyolefin composition further comprises a propylene polymer grafted with maleic anhydride.

27. The process for producing a 3D printed article according to claim 23, wherein the polyolefin composition has a MFR L (Melt Flow Rate according to ISO 1133, condition L, that is, 230° C. and 10. 2.16 kg load) ranging from 2.0 to 30.0 g/10 min.

28. The process for producing a 3D printed article according to claim 23, wherein the polyolefin composition has a MFR L (Melt Flow Rate according to ISO 1133, condition L, that is, 230° C. and 10. 2.16 kg load) ranging from 7.0 g/10 min to 15.0 g/10 min.

29. A process for producing articles with an extrusion-based additive manufacturing system further comprising the step of:
fusing deposited strands, drops, or beads of the heterophasic polypropylene composition A) of claim 13.

30. A process for producing articles with an extrusion-based additive manufacturing system further comprising the step of:
fusing deposited strands, drops, or beads of the filled polyolefin composition of claim 23.
